(19) United States
(12) Patent Application Publication
(10) Pub. No.: US 2002/0033809 A1
(43) Pub. Date: Mar. 21, 2002

(54) Display apparatus and method of driving same, and portable terminal apparatus

(76) Inventor: Yoshiharu Nakajima, Kanagawa (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 09/905,914

(22) Filed: Jul. 17, 2001

(30) Foreign Application Priority Data
Jul. 18, 2000 (JP) P2000-216976

(51) Int. Cl. G09G 5/00

(52) U.S. Cl. 345/204

(57) ABSTRACT

A matrix type display apparatus has a display area formed by a plurality of scan lines and a plurality of data lines arranged in a matrix manner, unit pixels arranged in a matrix manner and each having a sequential color arrangement in a vertical direction of a screen, and red, green and blue components corresponding to their respective colors of the pixels and arranged at the intersections of the scan lines and the data lines, wherein a horizontal driving circuit supplies to the data lines a data signal for each color a plurality of times during a horizontal period, while a vertical driving circuit supplies to the scan lines a selection pulse a plurality of times during the horizontal period.

### BACKGROUND OF THE INVENTION

The present invention relates to a display apparatus and a method of driving the same, and a portable terminal apparatus, and particularly to a matrix type color display apparatus and a method of driving the same, and a portable terminal apparatus using the same as a display unit.

FIG. 7 shows a conventional matrix type color display apparatus. The conventional matrix type color display apparatus has color filters arranged in longitudinal (vertical) stripes. A unit pixel 101 is formed as a set of three components (dots) of R (red), G (green), and B (blue) adjoining each other in a horizontal direction. In this case, a display apparatus having five pixels in a vertical direction (hereinafter abbreviated to vertical pixels) and eight pixels in a horizontal direction (hereinafter abbreviated to horizontal pixels) is taken as an example for simplicity of the figure.

A display area 102 formed by pixels 101 arranged in a matrix manner in the vertical-stripe color arrangement type display apparatus has a number of scan lines 103-1 to 103-5 corresponding to the number of vertical pixels and a number of data lines 104-1 to 104-24 corresponding to the number of horizontal pixels × the number of colors arranged (three colors in general), the scan lines and the data lines being arranged in a matrix manner. One end of each of the scan lines 103-1 to 103-5 is connected to an output terminal for one row of a vertical driving circuit 105. One end of each of the data lines 104-1 to 104-24 is connected to an output terminal for one column of a horizontal driving circuit 106.

The horizontal driving circuit 106 in the thus formed vertical-stripe color arrangement type display apparatus needs to drive the data lines 104-1 to 104-24 corresponding in number to that of horizontal pixels × that of colors arranged. Thus, the circuit scale of the horizontal driving circuit 106 and the number of outputs of the horizontal driving circuit 106 are increased. This results in problems such as an increase in the cost of the horizontal driving circuit 106 and difficulty in connecting wires between the horizontal driving circuit 106 and the display area 102.

A matrix type color display apparatus using a so-called selector system is known as a display apparatus for alleviating such problems. Also in the case of the matrix type color display apparatus using a selector system, color filters are arranged in vertical stripes, as shown in FIG. 8. A unit pixel 201 is formed as a set of three components of R, G, and B adjoining each other in a horizontal direction. Also in this case, a display apparatus having five vertical pixels and eight horizontal pixels is taken as an example for simplicity of the figure.

Also in the case of the matrix type color display apparatus using a selector system, a display area 202 formed by pixels 201 arranged in a matrix manner has a number of scan lines 203-1 to 203-5 corresponding to the number of vertical pixels and a number of data lines 204-1 to 204-24 corresponding to the number of horizontal pixels × the number of colors arranged, the scan lines and the data lines being arranged in a matrix manner. One end of each of the scan lines 203-1 to 203-5 is connected to an output terminal for one row of a vertical driving circuit 205.

The data lines 204-1 to 204-24 are connected to eight select switches 207-1 to 207-8 each for a set of three colors. Each of the select switches 207-1 to 207-8 comprises three analog switches S1, S2, and S3. One end of each of the three analog switches S1, S2, and S3 in the select switches 207-1 to 207-8 is connected to one of the data lines 204-1 to 204-24, while the other end of each of the three analog switches S1, S2, and S3 is connected to a common output terminal for one column of a horizontal driving circuit 206.

The thus formed matrix type display apparatus using the selector system sequentially outputs data signals in time series in order of R, G, and B, for example, from each output terminal of the horizontal driving circuit 206. In the meantime, the analog switches S1, S2, and S3 of the select switches 207-1 to 207-8 are switched a plurality of times (three times in this case) for each arranged color component by time division. Thus, the data signal for each color is sequentially supplied to the data lines 204-1 to 204-24.

The thus formed matrix type display apparatus using the selector system described above has an advantage of being able to reduce the number of outputs of the horizontal driving circuit 206 to one-third in this example. On the other hand, the matrix type display apparatus using the selector system requires the select switches 207-1 to 207-8 for assigning data signals to the data lines 204-1 to 204-24 corresponding to their respective colors and a switch control circuit (not shown) for generating control signals SEL1 to SEL3 for the select switches 207-1 to 207-8. Thus, circuit configuration of the display apparatus becomes complex.

### SUMMARY OF THE INVENTION

In view of the foregoing, the present invention has been made, and an object of the present invention to provide a display apparatus and a method of driving the same, and a portable terminal apparatus using the same as a display unit that make it possible to reduce the number of outputs of the horizontal driving circuit with a simple circuit configuration.

According to a first aspect of the present invention, there is provided a display apparatus including a display area formed by a plurality of scan lines and a plurality of data lines arranged in a matrix manner, unit pixels arranged in a matrix manner and each having a sequential color arrangement in a vertical direction of a screen, and a component arranged at an intersection of one of the scan lines and one of the data lines and corresponding to each color in each of the pixels; vertical driving means for sequentially supplying a selection signal to the plurality of scan lines; and horizontal driving means for supplying a data signal to the plurality of data lines.

According to a second aspect of the present invention, there is provided a method of driving a display apparatus, the display apparatus formed by a plurality of scan lines and a plurality of data lines arranged in a matrix manner, unit pixels arranged in a matrix manner and each having a sequential color arrangement in a vertical direction of a screen, and a component arranged at an intersection of one of the scan lines and one of the data lines and corresponding to each color in each of the pixels, said method comprising the step of supplying to the data lines a data signal for each color a plurality of times during a horizontal period, while supplying to the scan lines a selection signal a plurality of times during the horizontal period.

According to a third aspect of the present invention, there is provided a portable terminal apparatus having a display apparatus, the display apparatus including a display area formed by a plurality of scan lines and a plurality of data lines arranged in a matrix manner, unit pixels arranged in a matrix manner and each having a sequential color arrangement in a vertical direction of a screen, and a component arranged at an intersection of one of the scan lines and one of the data lines and corresponding to each color in each of the pixels; vertical driving means for sequentially supplying a selection signal to the plurality of scan lines; and horizontal driving means for supplying a data signal to the plurality of data lines.

With these configurations, by arranging unit pixels each having a sequential color arrangement in a vertical direction of a screen in a matrix manner and arranging a component corresponding to each color in each of the pixels at an intersection of a scan line and a data line in a matrix type display apparatus, color filters are arranged in lateral (horizontal) stripes. By employing the horizontal-stripe color arrangement, the number of outputs of a horizontal driving means becomes equal to that of horizontal pixels, and the number of outputs of a vertical driving means becomes equal to that of vertical pixels × that of colors arranged. Thus, it is possible to reduce the number of outputs of the horizontal driving means with a simple circuit configuration.

### BRIEF DESCRIPTION OF THE DRAWINGS

FIG. 1 is a block diagram showing a fundamental configuration of a matrix type color display apparatus according to an embodiment of the present invention;

FIG. 2 is a timing chart of assistance in explaining operation of the matrix type color display apparatus according to the embodiment of the present invention;

FIG. 3 is a block diagram showing a concrete example of the matrix type color display apparatus according to the embodiment of the present invention;

FIG. 4 is a timing chart of assistance in explaining operation of the matrix type color display apparatus in the concrete example;

FIG. 5 is a circuit diagram showing a configuration of a display area in an active matrix type liquid crystal display apparatus;

FIG. 6 is a schematic external view of a portable telephone to which the present invention is applied;

FIG. 7 is a block diagram showing a conventional matrix type display apparatus; and

FIG. 8 is a block diagram showing a conventional matrix type display apparatus using a selector system.

### DETAILED DESCRIPTION OF THE INVENTION

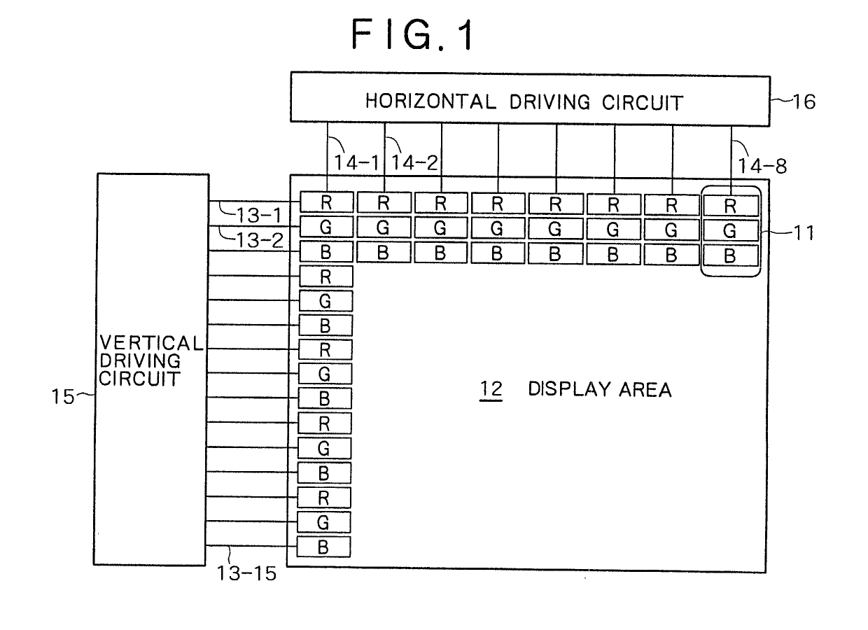

Hereinafter, preferred embodiments of the present invention will hereinafter be described in detail with reference to the drawings. FIG. 1 is a block diagram showing a fundamental configuration of a matrix type color display apparatus according to an embodiment of the present invention. In this case, a display apparatus having five vertical pixels and eight horizontal pixels is taken as an example for simplicity of the figure.

The matrix type display apparatus according to the present embodiment has a horizontal-stripe color arrangement in which color filters for R, G, and B, for example, are arranged in stripes in a lateral (horizontal) direction and the arrangement is repeated in a longitudinal (vertical) direction. A unit pixel 11 is formed as a set of three components (dots) of R, G, and B adjoining each other in the vertical direction. Unit pixels 11 arranged in a matrix manner form a display area 12. It is supposed in this case that the area of a unit pixel 11 formed by three dots is the same as in the vertical-stripe color arrangement.

The display area 12 has a number of scan lines 13-1 to 13-15 corresponding to the number of vertical pixels × the number of colors arranged (three colors in this case) and a number of data lines (column lines) 14-1 to 14-8 corresponding to the number of horizontal pixels, the scan lines and the data lines being arranged in a matrix manner. The components corresponding to their respective colors of the unit pixels 11 (R, G, and B dots in this case) are arranged at their respective intersections of the scan lines 13-1 to 13-15 and the data lines 14-1 to 14-8.

One end of each of the scan lines 13-1 to 13-15 is connected to an output terminal for one row of a vertical driving circuit 15. A selection pulse for selecting each of the components R, G, and B of the unit pixels 11 in a unit of a row is sequentially outputted from the vertical driving circuit 15 to the scan lines 13-1 to 13-15 as scanning in the vertical direction is performed. On the other hand, one end of each of the data lines 14-1 to 14-8 is connected to an output terminal for one column of a horizontal driving circuit 16. Data signals are outputted for each column in time series in order of R, G, and B, for example, from the horizontal driving circuit 16 to the data lines 14-1 to 14-8.

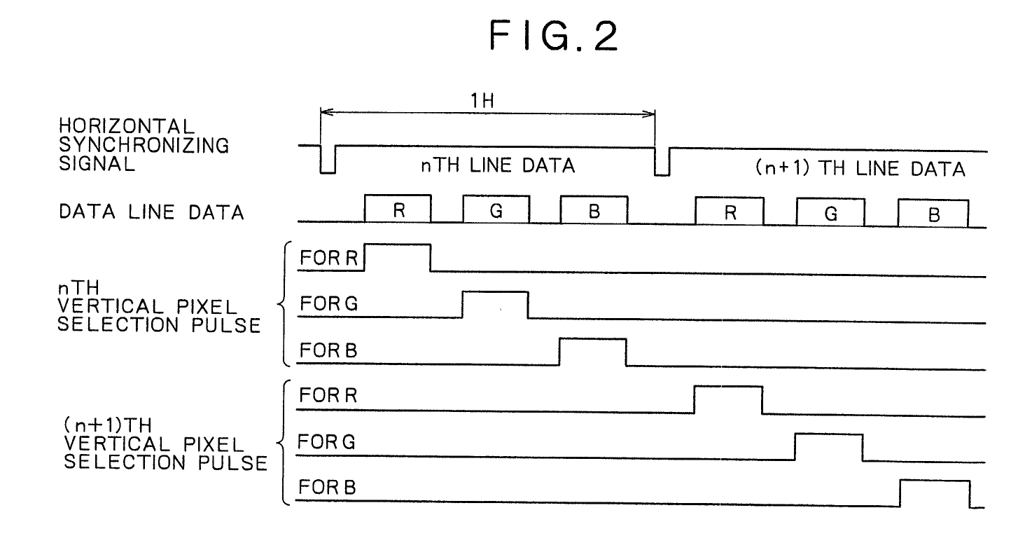

FIG. 2 shows a timing relation between R, G, and B data signals and selection pulses for an nth vertical pixel (nth line) and an (n+1)th vertical pixel ((n+1)th line), for example, in the matrix type color display apparatus according to the above embodiment having the horizontal-stripe color arrangement.

As is clear from the timing chart of FIG. 2, the R, G, and B data signals are sequentially outputted from the horizontal driving circuit 16 in synchronism with a horizontal synchronizing signal, and at the same time, the selection pulses for R, G, and B are sequentially outputted from the vertical driving circuit 15 to the nth vertical pixel. Data is thereby written to the components R, G, and B of the nth vertical pixel. Thus, the horizontal driving circuit 16 supplies a data signal for each color a plurality of times (three times in this case) during a period of 1 H (H is a horizontal period), while the vertical driving circuit 15 outputs a selection pulse three times during a period of 1 H.

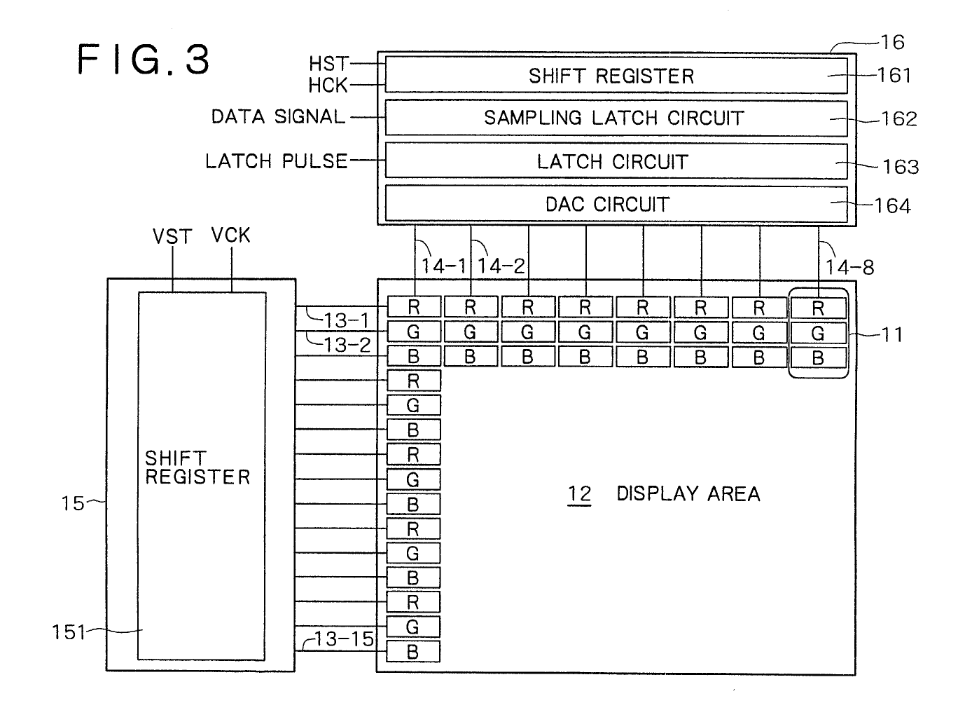

FIG. 3 is a block diagram showing concrete configurations of the vertical driving circuit 15 and the horizontal driving circuit 16 in the matrix type color display apparatus according to the above embodiment. In the figure, like reference characters to those of FIG. 1 denote like or equivalent elements.

First, the vertical driving circuit 15 in FIG. 3 is basically formed by a shift register 151. The shift register 151 is supplied with a vertical start pulse VST and a vertical clock pulse VCK. When the shift register 151 is supplied with the vertical start pulse VST, the shift register 151 performs shift operation in synchronism with the vertical clock pulse VCK, thereby sequentially outputting the selection pulses as described above. The vertical driving circuit 15 is produced together with the display area 12 on the same transparent insulating substrate by the same process.

Next, the horizontal driving circuit 16 has a shift register 161, a sampling latch circuit 162, a latch circuit 163, and a DAC (digital-to-analog converter) circuit 164.

The shift register 161 in the thus formed horizontal driving circuit 16 is supplied with a horizontal start pulse HST and a horizontal clock pulse HCK. When the shift register 161 is supplied with the horizontal start pulse HST, the shift register 161 performs shift operation in synchronism with the horizontal clock pulse HCK, thereby sequentially generating a sampling pulse in a cycle of the horizontal clock pulse HCK.

Data signals are inputted as serial data to the sampling latch circuit 162. The sampling latch circuit 162 sequentially samples the data signals in synchronism with the sampling pulses outputted from the shift register 161, and then latches the sampled data signals for one line (1 H) so as to correspond to each of the data lines 14-1 to 14-8 of the display area 12.

The latch circuit 163 relatches the data signals for one line corresponding to each of the data lines 14-1 to 14-8 of the display area 12 latched by the sampling latch circuit 162 for 1 H in response to latch pulses supplied in a cycle of 1 H. The DAC circuit 164 converts the data signals for one line latched by the latch circuit 163 into analog signals, and then supplies the analog data signals to the data lines 14-1 to 14-8 of the display area 12.

The horizontal driving circuit 16 is for example produced on a substrate separate from the transparent insulating substrate mounting the display area 12 and the vertical driving circuit 15 by a process different from that of the display area 12 and the vertical driving circuit 15. The horizontal driving circuit 16 is then connected to each of the data lines 14-1 to 14-8 of the display area 12 by COG (chip on glass) or TAB (tape automated bonding).

However, the horizontal driving circuit 16 is not necessarily limited to being produced on a substrate separate from the display area 12 and the vertical driving circuit 15; the horizontal driving circuit 16 may also be produced together with the display area 12 and the vertical driving circuit 15 on the same transparent insulating substrate by the same process.

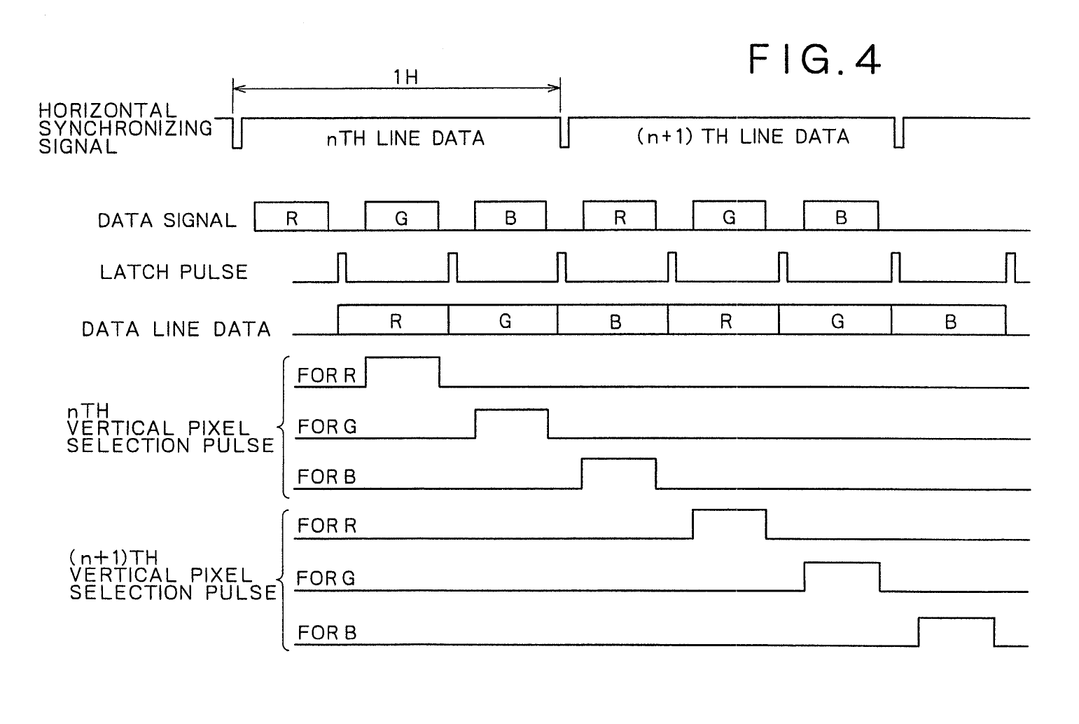

FIG. 4 shows a timing relation between selection pulses for an nth vertical pixel (nth line) and an (n+1)th vertical pixel ((n+1)th line), for example, R, G, and B data signals, latch pulses, and data line data in the matrix type color display apparatus according to the above embodiment having the horizontal-stripe color arrangement.

As is clear from the timing chart of FIG. 4, when a data signal for R in the nth line is inputted in synchronism with a horizontal synchronizing signal, the latch circuit 163 latches the data signal in synchronism with a latch pulse for a period corresponding to one line. The DAC circuit 164 thereafter converts the data signal into an analog signal, and then supplies the analog signal to each of the data lines 14-1 to 14-8 of the display area 12.

When the next data signal for G in the nth line is inputted, the vertical driving circuit 15 outputs a selection pulse for R to the nth vertical pixel in synchronism with the timing of inputting the data signal for G, for example. The data signal is thereby written to the component R of the nth vertical pixel. Then, the latch circuit 163 latches the data signal for G in the nth line in synchronism with a latch pulse for a period corresponding to one line. The DAC circuit 164 supplies the signal to each of the data lines 14-1 to 14-8 of the display area 12.

When the next data signal for B in the nth line is inputted, the vertical driving circuit 15 outputs a selection pulse for G to the nth vertical pixel in synchronism with the timing of inputting the data signal for B, for example. The data signal is thereby written to the component G of the nth vertical pixel. Then, the latch circuit 163 latches the data signal for B in the nth line in synchronism with a latch pulse for a period corresponding to one line. The DAC circuit 164 supplies the signal to each of the data lines 14-1 to 14-8 of the display area 12.

Thereafter, data signals are written to components of each pixel in the order of R, G, and B, for example, in the (n+1)th line, an (n+2)th line, . . . in that order. It is to be noted that the order in which the data is written to the components of each pixel is not limited to the order of R, G, and B; the order may be set arbitrarily.

As described above, the unit pixels 11 each having a sequential color arrangement in the vertical direction of the display area 12 are arranged in a matrix manner, and the components R, G, and B corresponding to their respective colors of the pixels are arranged at the intersections of the scan lines 13-1 to 13-15 and the data lines 14-1 to 14-8. Therefore it is possible to form a display system having a simple circuit configuration and a reduced number of outputs of the horizontal driving circuit 16. Thus, functions and effects as described below are obtained.

First, the number of wires connected between the display area 12 and the horizontal driving circuit 16 is reduced, and therefore it is easier to connect wires between the display area 12 and the horizontal driving circuit 16 even with a narrow pixel pitch. This makes it possible to further increase the number of horizontal pixels and thereby realize a higher-resolution display system.

In addition, since the horizontal driving circuit 16 has a very high operating frequency on the order of a few MHz, the circuit configuration of the horizontal driving circuit 16 tends to be complex as compared with the vertical driving circuit 15 having a relatively low operating frequency on the order of tens of kHz. However, the reduced number of outputs of the horizontal driving circuit 16 makes it possible to correspondingly reduce the circuit scale and circuit area of the horizontal driving circuit 16. Thus, the display system can be made more compact and reduced in cost.

While the matrix type color display apparatus according to the present embodiment triples the number of outputs of the vertical driving circuit 15, the operating frequency of the vertical driving circuit 15 is far lower than that of the horizontal driving circuit 16, as described above. Thus, even a tripled operating frequency of the vertical driving circuit 15 results in a slight increase in its circuit scale because of its simple circuit configuration formed basically by a shift register. Besides, the vertical driving circuit 15 can be formed by a polysilicon transistor, which does not have very good characteristics.

Moreover, since it is not necessary to provide select switches used in the selector system, which can realize the same number of outputs, the switch control circuit for controlling the select switches is not required, and also the number of wires connected between the display area 12 and the horizontal driving circuit 16 can be reduced. Thus, it is possible to reduce the cost and area of the display system and also lower power consumption by an amount consumed by the select switches and their control circuit.

In particular, when a data signal of a 0 V-5 V amplitude, for example, is to be written to the data lines via the select switches, and the select switches are formed by transistors, the switch control circuit used in the selector system needs to switch the transistors by a control pulse lower than 0 V, so that a negative power supply is required. On the other hand, the matrix type display apparatus according to the present embodiment eliminates the need for the switch control circuit and hence the need for providing a negative power supply.

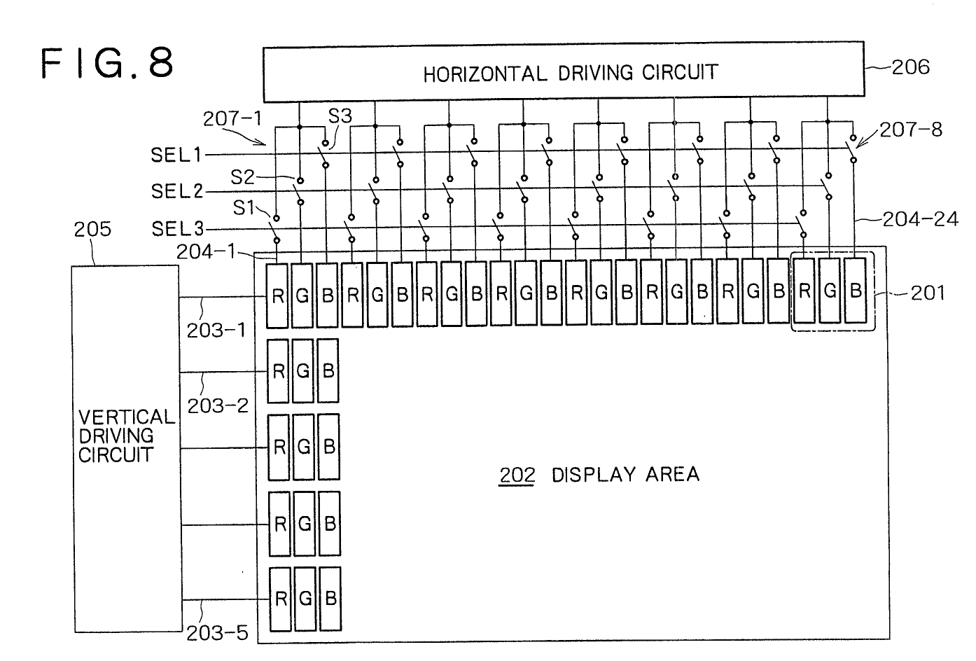

Furthermore, when the selector system of FIG. 8 is taken as an example, only one of the three switches S1 to S3 is brought into an on state (closed state), while the other two are brought into an off state (opened state). The data lines connected to the two switches are brought into a floating state. Then, a change in the potential of data lines in adjacent columns due to switching affects the data lines in the floating state, which results in a deterioration in picture quality. On the other hand, the matrix type display apparatus according to the present embodiment eliminates the need for the select switches. Thus, data lines are not brought into the floating state, whereby picture quality can be improved.

It is to be noted that in the above embodiment, the colors of the components of the unit pixels 11 are set to be R, G, and B; however, the present invention is not limited to this, and the colors of the components of the unit pixels 11 may be Ye (yellow), Cy (cyan), and Mg (magenta), for example.

Also, the matrix type display apparatus may be an active matrix type display apparatus in which pixel transistors are formed in an array, and a material having electro-optical effects is contained between two opposed transparent insulating substrates corresponding to an X-electrode and a Y-electrode (for example glass substrates) . Alternatively, the matrix type display apparatus may be a simple matrix type display apparatus in which a transparent conductive film (ITO; Indium Tin Oxide) is deposited as an electrode on two transparent insulating substrates, and an electric field is applied thereto.

Typical active matrix type display apparatus include a liquid crystal display (LCD) using an LC (liquid crystal) cell as a display element of each component (dot) formed by using a material having electro-optical effects and an EL display (ELD) using an EL (electroluminescence) element.

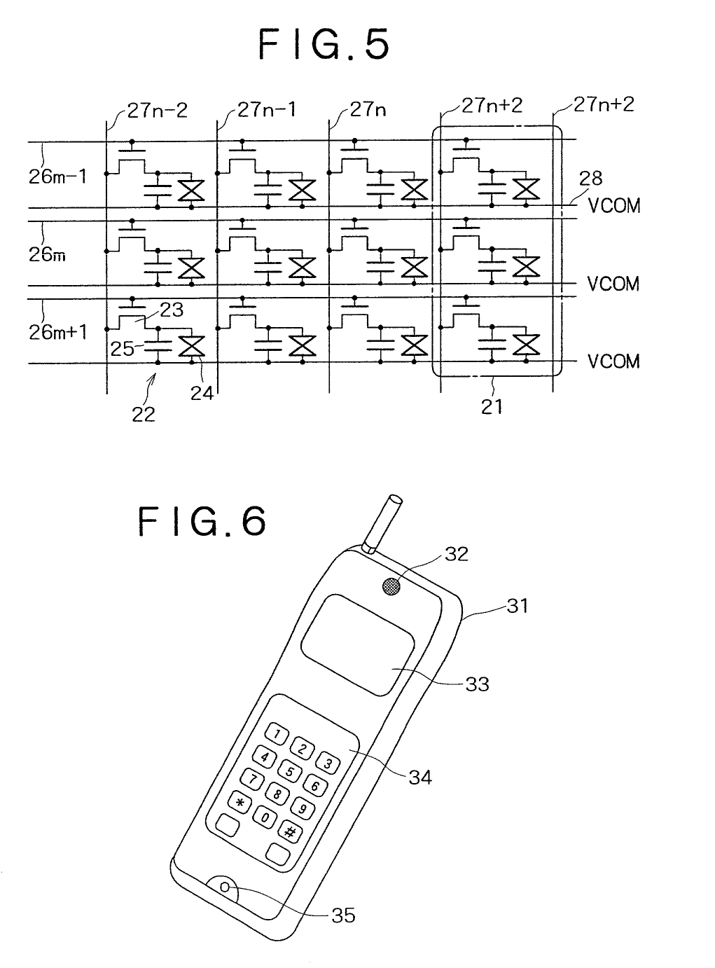

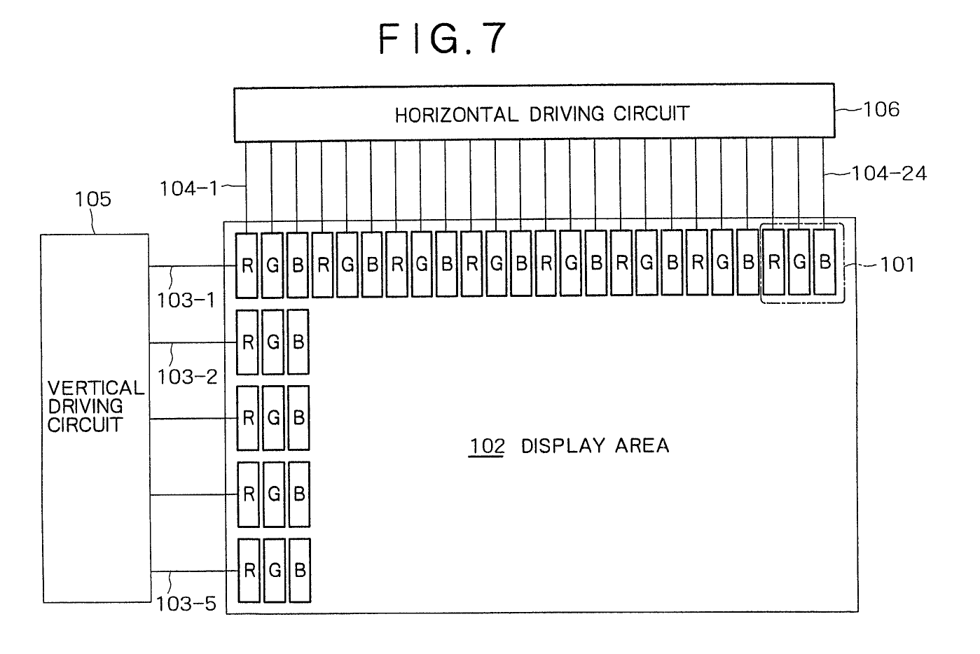

FIG. 5 shows a configuration of a typical display area in an active matrix type liquid crystal display apparatus. A unit pixel 21 in FIG. 5 comprises three components 22 adjoining each other in a longitudinal direction (vertical direction). The component 22 comprises: a TFT (Thin Film Transistor) 23, which is a pixel transistor; a liquid crystal cell 24 having a pixel electrode connected to a drain electrode of the TFT 23; and an auxiliary capacitance 25 having one electrode connected to the drain of the TFT 23.

In this pixel configuration, the TFTs 23 of the components 22 have gate electrodes connected to scan lines . . . , 26m−1, 26m, 26m+1, . . . , respectively. The TFTs 23 have source electrodes connected to data lines . . . , 27n−1, 27n, 27n+1, . . . , respectively. A counter electrode of the liquid crystal cell 24 and the other electrode of the auxiliary capacitance 25 are connected to a common line 28 to which a specified direct-current voltage is supplied as a common voltage VCOM.

The matrix type liquid crystal display apparatus according to the present embodiment is applicable to any of the following liquid crystal displays: a transmission type, in which a light source such as a backlight and a sidelight is disposed in the back and light is emitted from behind for display; a reflection type, which effects display by reflection of natural light, room light, or the like; and a transmission and reflection type, which combines the transmission type and the reflection type. However, when the common lines 28 shown in FIG. 5 are provided independently, the increased number of outputs of the vertical driving circuit 15 correspondingly increases the number of common lines 28. Therefore the matrix type liquid crystal display apparatus according to the present embodiment is more advantageous when applied to a liquid crystal display of the reflection type rather than the transmission type.

The matrix type display apparatus according to the present invention typified by the active matrix type liquid crystal display apparatus described above is suitable not only for use as a display of OA equipment such as a personal computer and a word processor, a television receiver or the like but also for use especially as a display unit of a portable terminal apparatus such as a PDA (personal digital assistant) or a portable telephone, which apparatus itself has been reducing its size, cost, and power consumption.

FIG. 6 is a schematic external view of a portable terminal apparatus, for example a portable telephone to which the present invention is applied.

The portable telephone in this embodiment has a speaker unit 32, a display unit 33, a control unit 34, and a microphone unit 35 arranged from the top down on the front side of an apparatus casing 31. The foregoing matrix type display apparatus according to the present invention is used as the display unit 33 of the thus formed portable telephone.

Thus, since the matrix type display apparatus according to the present invention is formed so as to enable reduction in its size, cost, and power consumption, the display apparatus used as the display unit 33 of the portable terminal apparatus such as the portable telephone can greatly contribute to reduction in the size, cost, and power consumption of the portable terminal apparatus.

While a preferred embodiment of the invention has been described using specific terms, such description is for illustrative purpose only, and it is to be understood that changes and variations may be made without departing from the spirit or scope of the following claims.

What is claimed is:

1. A display apparatus comprising:
a display area formed by a plurality of scan lines and a plurality of data lines arranged in a matrix manner, unit pixels arranged in a matrix manner and each having a sequential color arrangement in a vertical direction of a screen, and a component arranged at an intersection of one of said scan lines and one of said data lines and corresponding to each color in each of the pixels;
vertical driving means for sequentially supplying a selection signal to said plurality of scan lines; and
horizontal driving means for supplying a data signal to said plurality of data lines.

2. A display apparatus according to claim 1, wherein a display element of said component is formed by a liquid crystal cell or an electroluminescence element.

3. A display apparatus according to claim 1, wherein said horizontal driving means supplies to said data lines the data signal for each color a plurality of times during a horizontal period; and
said vertical driving means supplies to said scan lines the selection signal a plurality of times during the horizontal period.

4. A display apparatus according to claim 1, wherein said vertical driving means is produced together with said display area on an identical substrate by an identical process; and
said horizontal driving means is produced on a substrate separate from said substrate by a process different from that of said vertical driving means.

5. A display apparatus according to claim 1, wherein said vertical driving means and said horizontal driving means are produced together with said display area on an identical substrate by an identical process.

6. A method of driving a display apparatus, said display apparatus formed by a plurality of scan lines and a plurality of data lines arranged in a matrix manner, unit pixels arranged in a matrix manner and each having a sequential color arrangement in a vertical direction of a screen, and a component arranged at an intersection of one of said scan lines and one of said data lines and corresponding to each color in each of the pixels, said method comprising the step of:
supplying to said data lines a data signal for each color a plurality of times during a horizontal period, while supplying to said scan lines a selection signal a plurality of times during the horizontal period.

7. A method of driving a display apparatus according to claim 6, wherein a display element of said component is formed by a liquid crystal cell or an electroluminescence element.

8. A portable terminal apparatus having a display apparatus, said display apparatus comprising:
a display area formed by a plurality of scan lines and a plurality of data lines arranged in a matrix manner, unit pixels arranged in a matrix manner and each having a sequential color arrangement in a vertical direction of a screen, and a component arranged at an intersection of one of said scan lines and one of said data lines and corresponding to each color in each of the pixels;
vertical driving means for sequentially supplying a selection signal to said plurality of scan lines; and
horizontal driving means for supplying a data signal to said plurality of data lines.

9. A portable terminal apparatus according to claim 8, wherein a display element of said component is formed by a liquid crystal cell or an electroluminescence element.

10. A portable terminal apparatus according to claim 8, wherein said horizontal driving means supplies to said data lines the data signal for each color a plurality of times during a horizontal period; and
said vertical driving means supplies to said scan lines the selection signal a plurality of times during the horizontal period.
